(19) United States
(12) Patent Application Publication
(10) Pub. No.: US 2006/0102380 A1
(43) Pub. Date: May 18, 2006

(54) Multilayer insulating wire

(75) Inventor: Jen-Yao Hu, Tainan Hsien (TW)

Correspondence Address: BIRCH STEWART KOLASCH & BIRCH, PO BOX 747, FALLS CHURCH, VA, 22040-0747, US

(73) Assignee: Kuo Kuang Electronic Wire Co., Ltd.

(21) Appl. No.: 10/989,300

(22) Filed: Nov. 17, 2004

(51) Int. Cl. H01B 7/00

(52) U.S. Cl. 174/120 R

(57) ABSTRACT

The present invention discloses a multilayer insulating wire, which complies with the safety standards and comprises a conductor and at least two insulating layers covered onto the conductor. A fluorothermoplastic is used to form the insulating layer, and any two adjacent layers are comprised of different fluorothermoplastics to form mutually peeled insulating layers. The invention further has the features of the fluorothermoplastic materials, not only having the heat-resisting and pressure-resisting features, but also having the advantage of an insulating effect.

### FIELD OF THE INVENTION

The present invention relates to a multilayer insulating wire, more particularly to a multilayer insulating wire complying with safety standards and specifications.

### BACKGROUND OF THE INVENTION

In the International Electrotechnical Communication (IEC) Standard 60950, the winding of a transformer assembly complies with the following regulations:

(1) At least three insulating layers (any paint coating covered onto the conductor is not considered as an insulating layer) are formed between the primary winding and secondary winding, or the thickness of the insulating layer must be over 0.44 mm.

(2) Although the distance between the surface of the primary winding and the surface of the secondary winding depends on the applied voltage, the distance must be kept over 5 mm.

(3) If a voltage of 3000 volts (V) is applied to the primary winding and the secondary winding, it must be able to stand the voltage for over one minute.

At present, most of the transformers adopt an insulating barrier and an electrical insulating tape for its insulation, wherein the insulating barrier is disposed at a specific distance from both sides of the periphery of a bobbin of the iron core of the transformer, and then the electrical insulating tape wraps around a paint coated conductor for several times until it reaches a certain specific thickness to complete the whole insulation process. Alternatively, some manufacturers use the electrical insulating tape to wrap three insulating layers with the IEC standard as to omit the insulating barrier.

However, the wrapping of the electrical insulating tape according to the foregoing prior art is laborious. Further, it will cause poor insulation effect or even electric shocks if the electrical insulating tape breaks or has poor quality. The manufacture of these transformers involves a slow production, high-cost and laborious process, and thus these existing problems demand immediate attention and improvements.

Some patent inventors invented the three-layer wire to meet with the multilayer insulating wire that can comply with the safety regulations and standards. For examples, the U.S. Pat. Nos. 5,606,152, 6,753,478, 4,716,073, 4,711,811, 4,273,829 and 6,359,230 and the R.O.C. Pat. Nos. 374181, 388887, 409263 and 428178 disclosed a three-layer insulating layer being made of a polyamide (PA) material and complying with the three-layer insulating layers according to the safety regulations and standards. However, the PA materials have the properties of a lower level of heat resistance and an easier combustion, and also may produce toxic gases. If such insulating layer is used for winding transformers, it will cause a high temperature and a poor insulation effect. Therefore, such arrangement still has many problems.

### SUMMARY OF THE INVENTION

Therefore, the primary objective of the present invention is to overcome the foregoing shortcomings and avoid the exiting deficiency by providing a multilayer insulating wire having the heat-resisting, pressure-resisting and insulating effects.

Another objective of the present invention is to provide a multilayer insulating wire having the features of a simple manufacturing process and a low cost.

The multilayer insulating wire in accordance with the present invention comprises a conductor and at least two insulating layers covered onto the conductor, characterized in that a fluorothermoplastic is used to form an insulating layer and any two adjacent layers are comprised of different fluorothermoplastics to form mutually peeled insulating layers for avoiding a crack or break on another layer due to a crack or break of the insulating layer and resulting in a poor insulating effect.

The invention also features a good heat-resisting, pressure-resisting and insulating effect of the fluorothermoplastic material.

The above and other objects, features and advantages of the present invention will become apparent from the following detailed description taken with the accompanying drawing.

### BRIEF DESCRIPTION OF THE DRAWINGS

FIG. 1 is a cross-sectional view of the present invention.

FIG. 2 is a cross-sectional view of another preferred embodiment of the present invention.

FIG. 3 is an illustrative view of the winding of a transformer according to another preferred embodiment of the present invention.

### DETAILED DESCRIPTION OF THE PREFERRED EMBODIMENTS

The present invention makes use of the properties of a fluorothermoplastic material to overcome the complicated and laborious manufacturing process that uses the electrical insulating tape and insulating barrier according to the prior arts. The multilayer insulating wire of the invention complying with the thickness requirement of the insulating layer of the wire according to the safety regulations is described in detail with accompanied drawings as follows.

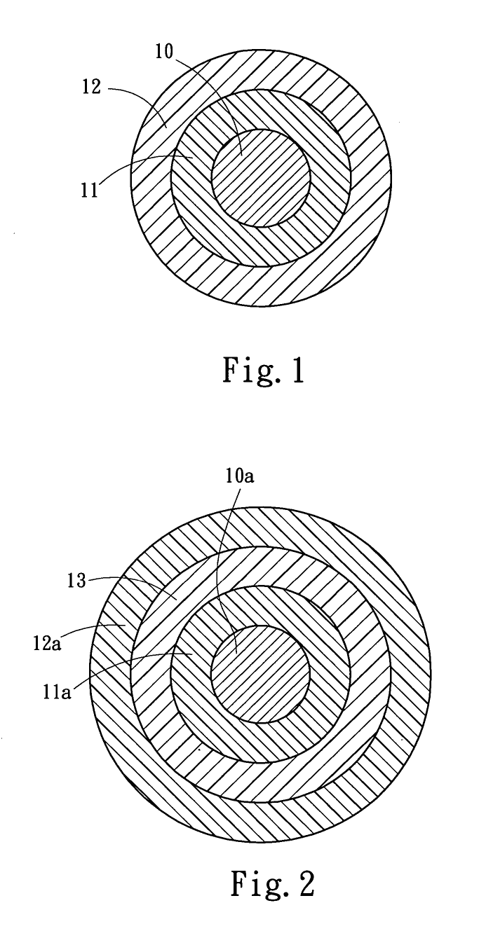

Please refer to FIG. 1 for the cross-sectional view of the present invention. FIG. 1 includes a conductor 10 and an insulating layer being covered onto the conductor 10 and comprised of an inner layer 11 and an outer layer 12; and the inner layer 11 and the outer layer 12 are made of different fluorothermoplastics. The fluorothermoplastics according to the preferred embodiments could be a fluorinated ethylene propylene (FEP), which is a copolymer of tetrafluroethene and hexafluoropropylene; a perfluoroalkoxy (PFA), which is a copolymer of tetrafluroethene and perfluoroalkyvinylether; an ethylene tetrafluoroethylene (ETFE), which is a copolymer of tetrafluroethene and ethylene; a tetrafluoroethylene hexafluoropropylene vinylidene fluoride (THV), which is a copolymer of tetrafluoroethylene, hexafluoropropylene, and vinylidene fluoride; or a polyvinylidene fluoride (PVDF) copolymer. The properties of these fluorothermoplastics will be described one by one below:

The fluorinated ethylene propylene (FEP) is a copolymer of tetrafluroethene and hexafluoropropylene, which has a low solubility and adhesiveness. Like other thermoplastic resins, the FEP can be manufactured by pressing, conducting, shooting and compressing. Since the bonding force between the carbon and fluorine atoms are very strong and the molecule is completely saturated with fluorine atoms, therefore the FEP copolymer has a high thermal, chemical and electrical stability. In the extremes of a temperature range, the FEP gives a very good performance for electrical, chemical and medical applications.

The perfluoroalkoxy (PFA) is a copolymer of tetrafluroethene and perfluoroalkyvinylether, which has a strong mechanical strength under high temperature and a very good plasticity. Therefore, the PFA can be used in the manufacture by pressing, compressing, blowing, conducting, and injection. Since the bonding force among the carbon, fluorine and oxygen atoms is strong and the PFA has a good performance in the temperature range of −200° C.˜+260° C., therefore PFA has a good transparency in the melting process.

The ethylene tetrafluoroethylene (ETFE) is a copolymer of tetrafluroethene and ethylene, which has excellent chemical, thermal and electric performances and an outstanding resistance to friction and penetration. Therefore, the ETFE is a key material for aviation, gas and chemical industries, and this product is also used extensively in the control room of a nuclear electricity station and many other occasions that require electric wires, ducts, low-permeability tubes, radiation-resisting coatings and construction coatings.

The ethylene tetrafluoroethylene (ETFE) is a copolymer of tetrafluroethene and ethylene, which has excellent performance and easiness for manufacturing coupling. Other melting manufacturing thermofluoroplastic material has no comparison with the ETFE.

The tetrafluoroethylene hexafluoropropylene vinylidene fluoride (THV) is a copolymer of tetrafluoroethylene, hexafluoropropylene and vinylidene fluoride, which has a special property used for soft tubes, pipelines, electrical wires, electrical cables, protective paint and low-permeability fuel combusting systems and provides outstanding applications in these areas. Further, more and more applications on special coatings and solar energy protective coatings are used.

The polyvinylidene fluoride (PVDF) copolymer is used extensively in the chemical industry, semiconductor industry and electrical wires and cables, including the automotive, construction, electronics, chemical, food and medical processes.

In view of the description on the structure and material properties of the present invention, a fluorothermoplastic is used to produce an insulating layer, and a different fluorothermoplastic is used for the adjacent inner layer 11 and outer layer 12 to produce a mutually peeled insulating layer for avoiding a crack or break on another layer (such as the inner layer 11 as shown in the figure) due to a crack or break of the insulating layer (such as the outer layer 12 as shown in the figure) and resulting in a poor insulating effect. The invention further has the features of the fluorothermoplastic materials, not only having the heat-resisting and pressure-resisting features, but also having the advantage of an insulating effect. The invention does not require an insulating tape or an insulating barrier for the insulation, and thus simplifying the manufacturing process and lowering the cost as well as complying with the thickness for the insulating layer of the wire as specified in the safety regulations and standards.

Please refer to FIG. 2 for another preferred embodiment of the present invention. FIG. 2 includes a conductor 10a and a three-layer insulating layer covered onto the conductor 10a, and any two adjacent layers are made of different fluorothermoplastics (just like the one as shown in FIG. 1). For example, an inner layer 11a proximate to the conductor 10a is FEP; a middle layer 13 adjacent to the inner layer 11a is PFA; an outer layer 12 adjacent to the middle layer is FEP or other PFA fluorothermoplastics.

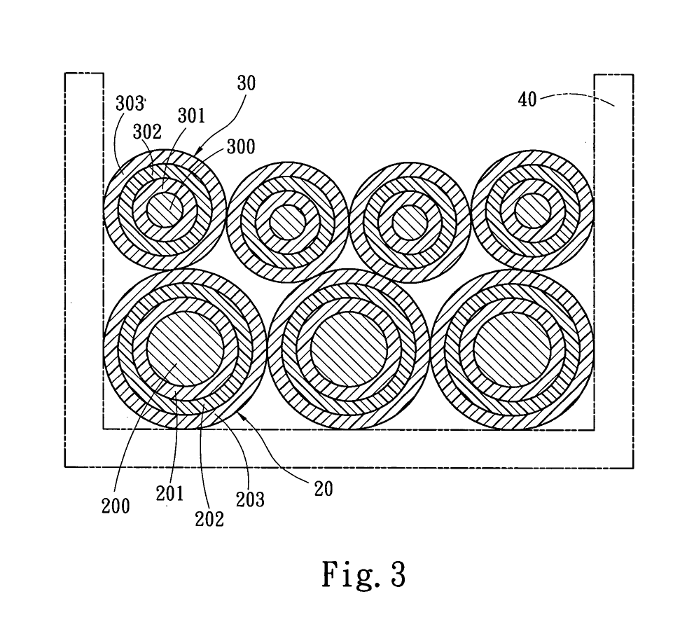

Please refer to FIG. 3 for an illustrative view of the winding of a transformer according to another preferred embodiment of the present invention, which comprises a primary winding 20, a secondary winding 30 and an iron core 40, wherein the primary winding 20 comprises a first conductor 200 and an insulating layer being covered onto the first conductor 200 and including a first internal layer 201, a first middle layer 202 and a first outer layer 203; and the secondary winding 30 comprises a second conductor 300 and an insulating layer being covered on the second conductor 300 and including a second internal layer 301, a second middle layer 302 and a second outer layer 303. The invention can omit the insulating barrier and insulating tape used in a prior-art transformer, and thus simplifying the manufacturing process and lowering the cost.

While the invention has been described by means of specific embodiments, numerous modifications and variations could be made thereto by those skilled in the art without departing from the scope and spirit of the invention set forth in the claims.

1. A multilayer insulating wire, comprising a conductor and at least two insulating layers covered onto said conductor, said at least two insulating layers being comprised of a fluorothermoplastic, the at least two insulating layers being adjacent layers and being comprised of different fluorothermoplastics,
a first one of the insulating layers being an extruded layer which is directly contacting the conductor with a second one of the insulating layers being an extruded layer which contacts the first layer, the at least two insulating layers forming mutually peeled insulating layers.

2. The multilayer insulating wire of claim 1, wherein said fluorothermoplastic if a fluorinated ethylene propylene (FEP), which is a copolymer of tetrafluroethene and hexafluoropropylene.

3. The multilayer insulating wire of claim 1, wherein said fluorothermoplastic is a perfluoroalkoxy (PFA), which is a copolymer of tetrafluroethene and perfluoroalkyvinylether.

4. The multilayer insulating wire of claim 1, wherein said fluorothermoplastic is an ethylene tetrafluoroethylene (ETFE), which is a copolymer of tetrafluroethene and ethylene.

5. The multilayer insulating wire of claim 1, wherein said fluorothermoplastic is a tetrafluoroethylene hexafluoropropylene vinylidene fluoride (THV), which is a copolymer of tetrafluoroethylene, hexafluoropropylene, and vinylidene fluoride.

6. The multilayer insulating wire of claim 1, wherein said fluorothermoplastic is a polyvinylidene fluoride (PVDF) copolymer.

7. The multilayer insulating wire of claim 1, wherein the at least two insulating layers include three extruded layers of different fluorothermoplastics.
